(19) United States
(12) Patent Application Publication
(10) Pub. No.: US 2012/0178337 A1
(43) Pub. Date: Jul. 12, 2012

(54) Stand for a Figure

(76) Inventor: Mark Wittenberg, Rossmoor, CA (US)

(21) Appl. No.: 12/987,078

(22) Filed: Jan. 7, 2011

(51) Int. Cl. A63H 3/50; F16M 11/04

(52) U.S. Cl. 446/268; 248/121

(57) ABSTRACT

A stand for a figure includes a base, a support member, and a receiving portion. The receiving portion includes a first leg receiving member and a second leg receiving member. Each leg receiving member is configured to receive a leg of a figure, such as a doll. The location at which the legs of a doll are supported is forward of the location at which the support member is coupled to a base.

### FIELD OF THE INVENTION

The present invention relates generally to a stand for a figure, such as a doll.

### BACKGROUND OF THE INVENTION

Various stands or structures for supporting different types of figures are known. Often such stands are used to support a figure, such as a doll, in a decorative or displaying manner. There are several drawbacks from conventional stands. Some such stands are large in size. Other stands interfere with the doll or its garments. Still other stands are too obtrusive in the overall appearance of the doll. In other words, too much of those stands is visible when looking at the figure.

There is a need for a stand that adequately and stably supports a figure in a manner that does not interfere with the visual and aesthetic appearance of the figure.

### SUMMARY OF THE INVENTION

In one embodiment of the invention, a stand for supporting a doll having a first leg and a second leg comprises a base configured to contact a support surface, a support member coupled to the base and extending upwardly and forwardly therefrom, and a receiving member coupled to the support member, the receiving member including a first receiving portion defining a first receptacle and a second receiving portion defining a second receptacle separate from the first receptacle, the first receptacle receiving the first leg of the doll and the second receptacle receiving the second leg of the doll to support the doll relative to the support surface.

In one embodiment, the support member has a first end and a second end opposite the first end, the first end of the support member is coupled to the base, and the receiving member is coupled to the second end of the support member.

In one embodiment, the support member has a first side and a second side opposite the first side, the first receiving portion is located on the first side of the support member and the second receiving portion is located on the second side of the support member. In addition, the first receiving portion is oriented in a first direction, the second receiving portion is oriented in a second direction, the first direction being opposite to the second direction.

In one embodiment, the first receiving portion includes a first substantially circular clip that defines the first receptacle, and the second receiving portion includes a second substantially circular clip that defines the second receptacle. In addition, the first substantially circular clip includes an opening that is located on a portion of the first substantially circular clip that is oriented away from the second substantially circular clip.

In one embodiment, the base has a front end and a rear end, the support member is coupled to the base at a first location, the receiving member is coupled to the support member at a second location, the distance between the second location and the front end of the base being less than the distance between the first location and the front end of the base, and the first receiving portion and second receiving portion are located on opposite sides of the second location.

In one embodiment, the first receiving portion includes a first wall member and a second wall member, the first wall member and the second wall member collectively defining the first receptacle, and the second receiving portion includes a third wall member and a fourth wall member, the third wall member and the fourth wall member collectively defining the second receptacle. In addition, each of the wall members includes an end, the end of the first wall member is spaced apart from the end of the second wall member thereby defining a first gap therebetween, and the end of the third wall member is spaced apart from the end of the fourth wall member thereby defining a second gap therebetween. Also, the first receiving portion includes a proximal portion proximate to the support member and a distal portion opposite to the proximal portion, the first gap is located along the distal portion of the first receiving portion, the second receiving portion includes a proximal portion proximate to the support member and a distal portion opposite to its proximal portion, and the second gap is located along the distal portion of the second receiving portion.

In another embodiment, a stand for a doll having a first leg and a second leg comprises a base configured to contact a support surface, the base having a front end and a rear end opposite the front end, and a support assembly coupled to the base, the support assembly including a support coupled to the base and extending upwardly therefrom, the support having a lower end and an upper end, the support being oriented so that the lower end of the support is coupled to the base and the upper end of the support extends toward the front end of the base, a first leg receiving portion coupled to the support, the first leg receiving portion configured to engage the first leg of the doll at a first location spaced apart from the support surface, a distance between the first location and the front end of the base being less than a distance between the lower end of the support and the front end of the base, and a second leg receiving portion coupled to the support and oriented in a direction extending away from the first leg receiving portion, the second leg receiving portion configured to engage the second leg of the doll at a second location spaced apart from the support surface, a distance between the second location and the front end of the base being less than a distance between the lower end of the support and the front end of the base.

In one embodiment, the first leg receiving portion defines a first receptacle in which the first leg of the doll can be inserted, and the second leg receiving portion defines a second receptacle in which the second leg of the doll can be inserted.

In one embodiment, the first leg receiving portion includes a first movable member and a second movable member, the first movable member and the second movable member collectively defining a first receptacle in which the first leg of the doll can be inserted, and the second leg receiving portion includes a third movable member and a fourth movable member, the third movable member and the fourth movable member collectively defining a second receptacle in which the second leg of the doll can be inserted. In addition, distal ends of the first movable member and the second movable member are spaced apart from each other, and distal ends of the third movable member and the fourth movable member are spaced apart from each other. Alternatively, the first movable member and the second movable member extend outwardly from a first side of the support portion, and the third movable member and the fourth movable member extend outwardly from a second side of the support portion, the second side being opposite the first side.

In one embodiment, the upper end of the support member is located between the first leg and the second leg of the doll.

In another embodiment, a toy assembly including a stand for a doll having a first leg and a second leg, the first leg having an outer surface defining a perimeter, the second leg having an outer surface defining a perimeter, comprises a stand including a base, a support member coupled to the base and extending upwardly therefrom, a first receiving portion coupled to the support member, at least a portion of the first receiving portion being located between the first leg and the second leg of the doll, the first receiving portion extending around a majority of the perimeter of the first leg, and a second receiving portion coupled to the support member, at least a portion of the second receiving portion being located between the first leg and the second leg of the doll, the second receiving portion extending around a majority of the perimeter of the second leg.

In one embodiment, the first receiving portion defines a receptacle in which the first leg is inserted, and the second receiving portion defines a receptacle in which the second leg is inserted.

In one embodiment, the first receiving portion extends from a first side of the support member, the second receiving portion extends from a second side of the support member, the first side being opposite to the second side.

In one embodiment, the toy assembly further comprises the doll.

### BRIEF DESCRIPTION OF THE DRAWINGS

FIG. 1 illustrates a front perspective view of a figure and a stand according to an embodiment of the invention.

FIG. 2 illustrates a front view of the figure and stand illustrated in FIG. 1.

FIG. 3 illustrates a rear view of the figure and stand illustrated in FIG. 1.

FIG. 4 illustrates a perspective view of a stand according to an embodiment of the invention.

FIG. 5 illustrates a partial exploded perspective view of some components of the stand illustrated in FIG. 4.

FIG. 6 illustrates a top view of the receiving portion of the stand illustrated in FIG. 4.

Like reference numerals have been used to identify like elements throughout this disclosure.

### DETAILED DESCRIPTION OF THE INVENTION

The present invention relates to a stand for a figure, such as a doll. According to the invention, the stand supports the figure or doll in a manner that does not interfere with the overall appearance of the figure as well as any garments being worn by the figure. For example, a doll, such as a fashion doll, may have a visually appealing garment such as a dress. The stand is used to support the doll with its dress without detracting from the overall appearance thereof. In some uses, it is desirable for the doll to be supported upright in a standing position, which facilitates the doll being displayed. One type of doll that can be displayed is a collector doll, which may include certain ornamentation or garments, such as a dress or other clothing. Ideally, the doll is supported by a support that is not in the way, physically and/or visually, of the doll or its ornamentation.

As described below, the stand according to the invention includes a base, a support member coupled to the base, and receiving portions coupled to the support member. Each of the receiving portions is configured to receive a portion of the doll, which facilitates supporting the doll stably in an upright configuration.

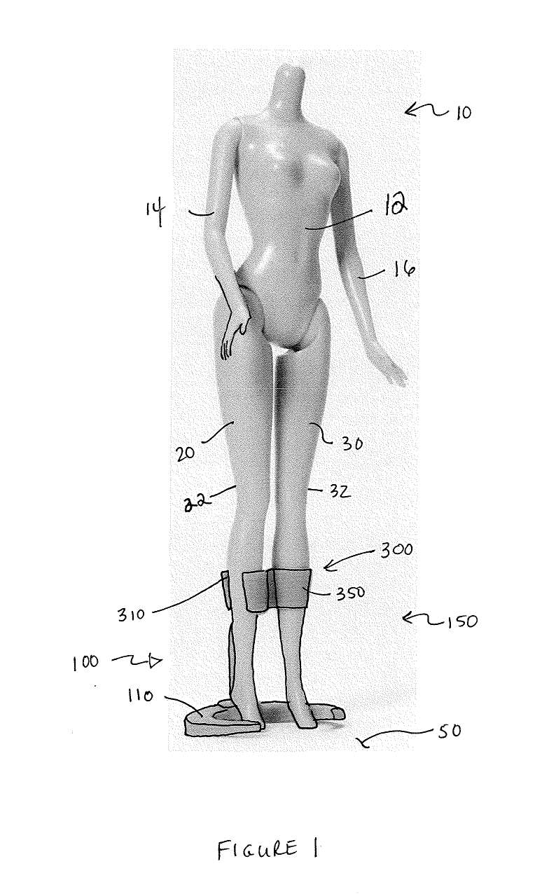

Referring to FIG. 1, an exemplary stand according to the invention and a doll are illustrated. In this embodiment, the doll 10 is representative of a figure that can be used with the stand 100. It can be appreciated that dolls with different appearances can be used with the stand 100. Returning to the exemplary doll 10, the doll 10 has a body 12 with arms 14 and 16 and legs 20 and 30, each of which in this embodiment is movable relative to the body 12. In other embodiments, the arms 14 and 16 and/or the legs 20 and 30 can be integrally formed with or fixedly coupled to the body 12.

Leg 20 has an outer surface 22 that defines an outer perimeter of the leg 20. Similarly, leg 30 has an outer surface 32 that defines an outer perimeter of leg 30. As will be discussed in greater detail below, each of the outer surfaces 22 and 32 of the doll legs 20 and 30 can have a tapered configuration, which resembles that of a human's leg.

Referring to FIGS. 1-3, different views of an embodiment of a stand 100 according to the present invention are illustrated. The stand 100 is configured to receive a portion of the doll 10 and to support the doll 10 relative to a support surface 50. In one embodiment, the stand 100 is formed of molded plastic material.

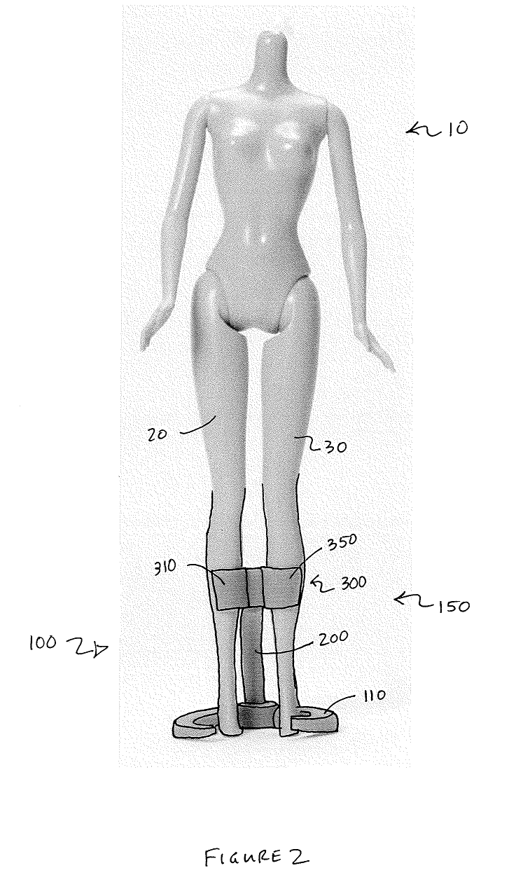

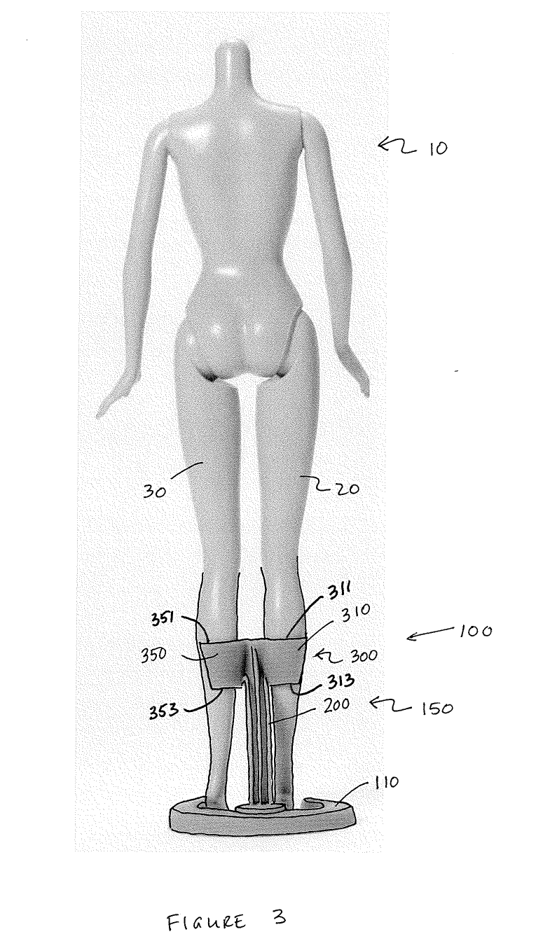

The stand 100 includes a base 110 that can be placed onto the support surface 50. The base 110 has a lower surface that is generally flat and configured to contact the support surface 50. Coupled to the base 110 is a support assembly 150 that includes a support member 200 (see FIGS. 2 and 3) and a receiving member 300. The support member 200 is coupled to the base 110 and extends upwardly therefrom. As described in detail below, the support member 200 also extends forwardly relative to the base 110. The support member 200 holds the receiving member 300 at a particular distance above the support surface 50. The receiving member 300 is configured to receive a portion of the doll 10, such as the legs 20 and 30 of the doll 10, as described below.

In one embodiment, the base 110, the support member 200, and the receiving member 300 are integrally formed together. In another embodiment, the base 110 and the support member 200 are formed together and the receiving member 300 is coupled to the support member 200.

As shown, the receiving member 300 includes receiving portions 310 and 350 that receive legs 20 and 30, respectively, of the doll 10. The receiving portions 310 and 350 are configured to extend around a majority of or substantially all of the perimeter of a portion of the legs 20 and 30. As visible in FIG. 1, receiving portion 310 includes a gap or opening, which is described in greater detail below. Receiving portion 350 includes a gap or opening similarly located on the outer side of the portion 350.

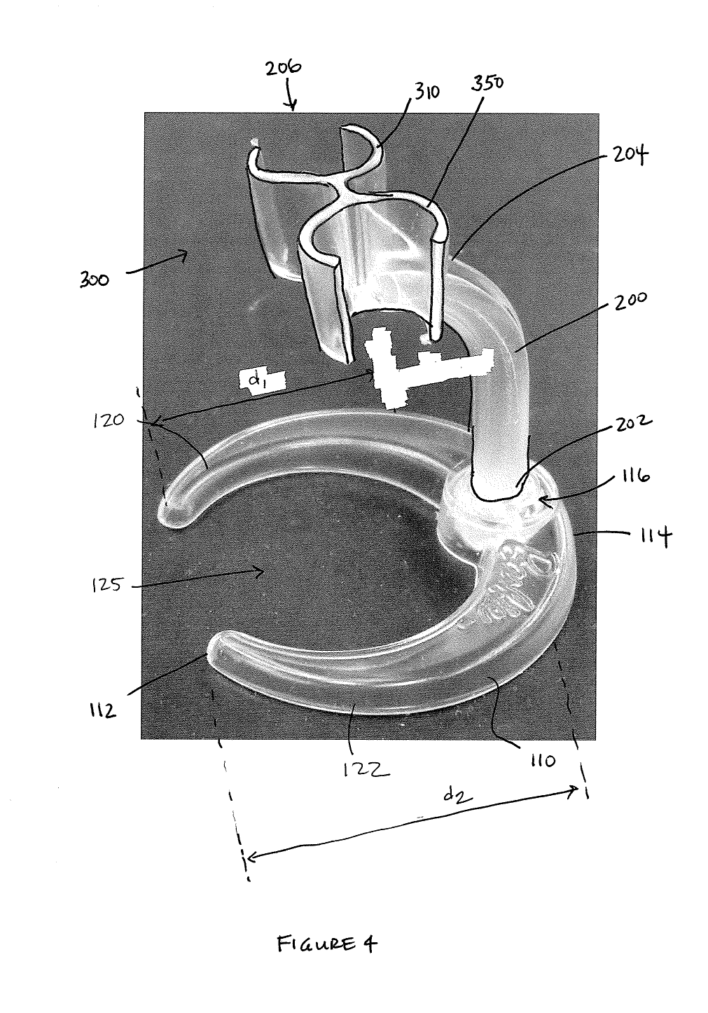

Referring to FIGS. 4-6, an embodiment of a stand according to the invention is illustrated. Like reference numerals are used for components that are in both the stand illustrated in FIGS. 1-3 and the stand illustrated in FIG. 4, which have similar overall configurations or shapes.

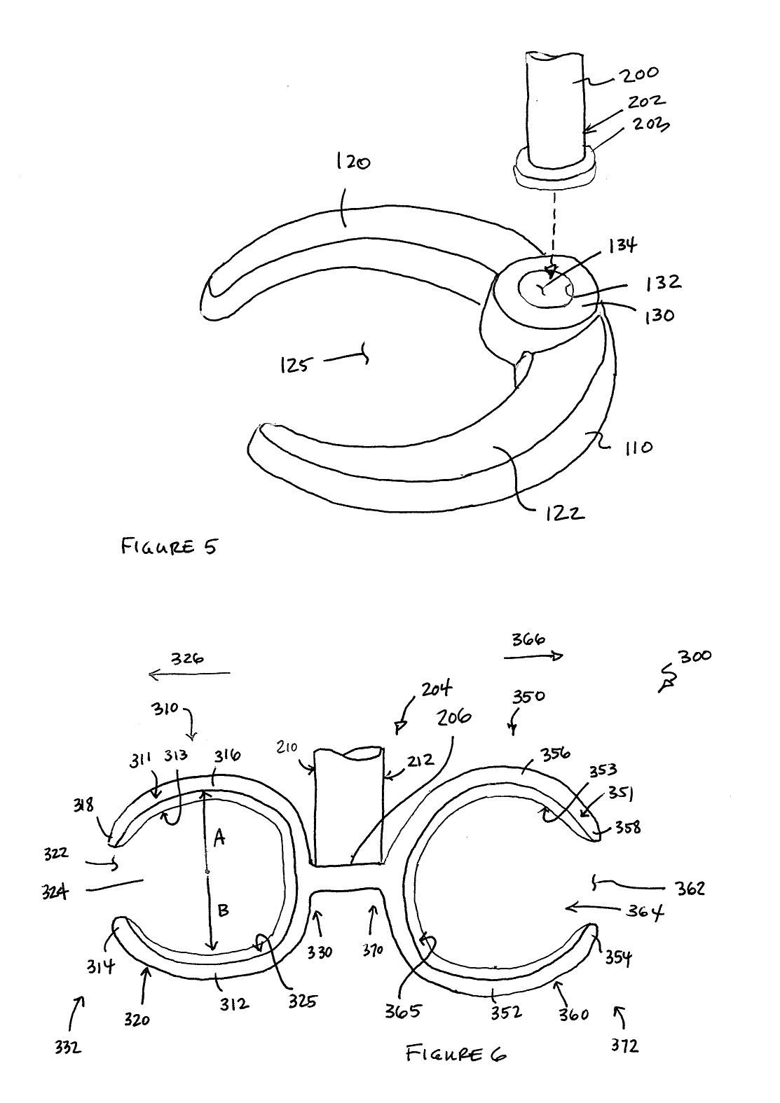

As illustrated in FIGS. 4 and 5, the base 110 has a substantially circular or arcuate shape. The base 110 has a front end 112 and an opposite, rear end 114. The base 110 includes two arm portions 120 and 122 that extend between the front end 112 and the rear end 114. Each of the arm portions 120 and 122 is curved, thereby defining an area 125 in which the feet of a doll supported by the stand 100 can be located. The area 125 provides clearance so that the feet do not contact either of the arm portions 120 and 122. In addition, the distal ends of the arm portions 120 and 122 are spaced apart, which allows the feet of a doll supported by the stand 100 to be visible from the front of the stand 100.

The support member 200 has a first or lower end 202 that is coupled to the base 110. The support member 200 also has a second or upper end 204 that is coupled to the receiving member 300. Referring to FIG. 4, the support member 200 has a curved configuration that results in the upper end 202 at location 206, which corresponds to where the legs are supported, being closer to the front end of the base 110 than the location 116 at which the lower end 204 is coupled to the base 110. In other words, the distance (d1) between location 206 and the front end 112 of the base 110 is less than the distance (d2) between the lower end 202 of the support member 200 at location 116 and the front end 112 of the base 110. Thus, location 206 ensures that the feet of the doll 10 are located in area 125.

The support member 200 approaches the receiving member 300 from the rear of the stand 100 and is coupled to the back of the receiving member 300, thereby resulting in a cleaner structure visually. The result of this configuration is that the receiving member 300 is in front of the support member 200, which also keeps the support member 200 from being located and extending between the legs of the doll 10.

Referring to FIG. 5, the base 110 also includes a mounting portion 130 that has an inner wall or surface 132 that defines a receptacle 134 into which the lower end 202 of the support member 200 can be inserted. In one embodiment, the lower end 202 can be snapped into the receptacle 134 and retained therein via an enlarged portion 203.

Referring to FIG. 6, a top view of the receiving portion 300 is shown in greater detail. The upper end 204 of the support member 200 has opposite sides 210 and 212, which may be referred to as a first side 210 and a second side 212. The upper end 204 is connected to the receiving portion 300 proximate to location 206. Accordingly, only the tip of the upper end 204 is located between the doll legs. In this embodiment, the support member 200 is integrally formed with the receiving member 300.

The receiving member 300 includes leg receiving portions 310 and 350, as discussed above. The leg receiving portions 310 and 350 are located so that they are facing opposite directions from each other relative to the support member 200. As shown, leg receiving portion 310 is oriented outwardly along the direction of arrow 326. Similarly, leg receiving portion 350 is oriented outwardly along the direction of arrow 366.

Leg receiving portion 310 forms a substantially cylindrical and/or circular clip 320 that defines a receptacle 324 into which a leg of the doll is inserted. The clip 320 has a proximal portion 330 that is located adjacent to the support member 200 and a distal portion 332 that is oriented outwardly. The proximal portion 330 is located on the inner surface of the receiving portion 310. The leg receiving portion 310 is formed of a first wall member or movable member 312 with a distal end 314 and a second wall member or movable member 316 with a distal end 318. The wall members 312 and 316 have some flexibility such that the distal ends 314 and 318 can be moved toward and away from each other to vary the size of the opening or gap 322 therebetween. This adjustability of the wall members 312 and 316 permits legs of different sizes and perimeters to be inserted between the wall members 312 and 316.

The wall members 312 and 316 collectively have an inner surface 325 that defines the receptacle 324. As shown, the inner surface 325 is tapered between an upper end 311 and a lower end 313 (see also FIG. 3). The width of the leg receiving portion 310, and as a result, the diameter of the receptacle 324, at the upper end 311 is larger than it is at the lower end 313. The radius “A” at the upper end 311 is larger than the radius “B” at the lower end 313. This provides a tapered profile to the leg receiving portion 310 that corresponds to a typical tapered outer surface of a leg of a doll.

Similarly, leg receiving portion 350 forms a substantially cylindrical and/or circular clip 360 that defines a receptacle 364 into which another leg of the doll is inserted. The clip 360 has a proximal portion 370 that is located adjacent to the support member 200 and a distal portion 372 that is oriented outwardly. The proximal portion 370 is located on the inner surface of the receiving portion 350. The leg receiving portion 350 is formed of a first wall member or movable member 352 with a distal end 354 and a second wall member or movable member 356 with a distal end 358. The wall members 352 and 356 have some flexibility such that the distal ends 354 and 358 can be moved toward and away from each other to vary the size of the opening or gap 362 therebetween. This adjustability of the wall members 352 and 356 permits legs of different sizes and perimeters to be inserted between the wall members 352 and 356. The wall members 352 and 356 collectively have an inner surface 365 that defines the receptacle 364. The inner surface 365 is tapered between a wider upper end 351 and a narrower lower end 353 in a manner similar to inner surface 325 described above.

By supporting the receiving portion 300 at a central location with respect to the clips 320 and 360, the support member 200 does not interfere with nor is it located between the legs of the doll 10. Also, the orientation of the gaps 322 and 362 outwardly permits different sized legs to be inserted into the receptacles 324 and 364 while still being supported at the same locations (the proximal portions 330 and 370), which ensures consistent and stable support of the different dolls.

In one embodiment, the leg receiving portions 310 and 350 are symmetrical relative to the support member 200 and a longitudinal axis of the support member 200. The symmetrical arrangement ensures that uniform support is provided to the doll 10 by the stand 100.

As shown in FIG. 4, the legs of a doll are supported at a location 206 which is closer to the front end 112 of the base 110 (see distance dl) than the location 116 at which the support member 200 is coupled to the base 110 to the front end 112 (see distance d2). As a result, the doll legs are supported such that the stand 100 does not interfere with the feet of the doll. In addition, the support member 200 is not located between the legs of the doll, which would take away from the overall aesthetic appearance of the doll. In addition, in one embodiment, the stand 100 can be made of a clear plastic material, which does not distract from the appearance of the doll or any garments disposed on the doll.

It is to be understood that terms such as “left,” “right,” “top,” “bottom,” “front,” “rear,” “side,” “height,” “length,” “width,” “upper,” “lower,” “interior,” “exterior,” “inner,” “outer,” “horizontal,” “vertical,” and the like as may be used herein, merely describe points or portions of reference and do not limit the present invention to any particular orientation or configuration. Further, terms such as “first,” “second,” “third,” etc., merely identify one of a number of portions, components, directions and/or points of reference as disclosed herein, and do not limit the present invention to any particular configuration or orientation.

Although the disclosed inventions are illustrated and described herein as embodied in one or more specific examples, it is nevertheless not intended to be limited to the details shown, since various modifications and structural changes may be made therein without departing from the scope of the inventions and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

What is claimed is:

1. A stand for supporting a doll having a first leg and a second leg, the stand comprising:
a base configured to contact a support surface;
a support member coupled to the base and extending upwardly and forwardly therefrom; and
a receiving member coupled to the support member, the receiving member including a first receiving portion defining a first receptacle and a second receiving portion defining a second receptacle separate from the first receptacle, the first receptacle receiving the first leg of the doll and the second receptacle receiving the second leg of the doll to support the doll relative to the support surface.

2. The stand of claim 1, wherein the support member has a first end and a second end opposite the first end, the first end of the support member is coupled to the base, and the receiving member is coupled to the second end of the support member.

3. The stand of claim 1, wherein the support member has a first side and a second side opposite the first side, the first receiving portion is located on the first side of the support member and the second receiving portion is located on the second side of the support member.

4. The stand of claim 3, wherein the first receiving portion is oriented in a first direction, the second receiving portion is oriented in a second direction, the first direction being opposite to the second direction.

5. The stand of claim 1, wherein the first receiving portion includes a first substantially circular clip that defines the first receptacle, and the second receiving portion includes a second substantially circular clip that defines the second receptacle.

6. The stand of claim 5, wherein the first substantially circular clip includes an opening that is located on a portion of the first substantially circular clip that is oriented away from the second substantially circular clip.

7. The stand of claim 1, wherein the base has a front end and a rear end, the support member is coupled to the base at a first location, the receiving member is coupled to the support member at a second location, the distance between the second location and the front end of the base being less than the distance between the first location and the front end of the base, and the first receiving portion and second receiving portion are located on opposite sides of the second location.

8. The stand of claim 1, wherein the first receiving portion includes a first wall member and a second wall member, the first wall member and the second wall member collectively defining the first receptacle, and the second receiving portion includes a third wall member and a fourth wall member, the third wall member and the fourth wall member collectively defining the second receptacle.

9. The stand of claim 8, wherein each of the wall members includes an end, the end of the first wall member is spaced apart from the end of the second wall member thereby defining a first gap therebetween, and the end of the third wall member is spaced apart from the end of the fourth wall member thereby defining a second gap therebetween.

10. The stand of claim 9, wherein the first receiving portion includes a proximal portion proximate to the support member and a distal portion opposite to the proximal portion, the first gap is located along the distal portion of the first receiving portion, the second receiving portion includes a proximal portion proximate to the support member and a distal portion opposite to its proximal portion, and the second gap is located along the distal portion of the second receiving portion.

11. A stand for a doll having a first leg and a second leg, the stand comprising:
a base configured to contact a support surface, the base having a front end and a rear end opposite the front end; and
a support assembly coupled to the base, the support assembly including:
a support coupled to the base and extending upwardly therefrom, the support having a lower end and an upper end, the support being oriented so that the lower end of the support is coupled to the base and the upper end of the support extends toward the front end of the base;
a first leg receiving portion coupled to the support, the first leg receiving portion configured to engage the first leg of the doll at a first location spaced apart from the support surface, a distance between the first location and the front end of the base being less than a distance between the lower end of the support and the front end of the base; and
a second leg receiving portion coupled to the support and oriented in a direction extending away from the first leg receiving portion, the second leg receiving portion configured to engage the second leg of the doll at a second location spaced apart from the support surface, a distance between the second location and the front end of the base being less than a distance between the lower end of the support and the front end of the base.

12. The stand of claim 11, wherein the first leg receiving portion defines a first receptacle in which the first leg of the doll can be inserted, and the second leg receiving portion defines a second receptacle in which the second leg of the doll can be inserted.

13. The stand of claim 11, wherein the first leg receiving portion includes a first movable member and a second movable member, the first movable member and the second movable member collectively defining a first receptacle in which the first leg of the doll can be inserted, and the second leg receiving portion includes a third movable member and a fourth movable member, the third movable member and the fourth movable member collectively defining a second receptacle in which the second leg of the doll can be inserted.

14. The stand of claim 13, wherein distal ends of the first movable member and the second movable member are spaced apart from each other, and distal ends of the third movable member and the fourth movable member are spaced apart from each other.

15. The stand of claim 13, wherein the first movable member and the second movable member extend outwardly from a first side of the support portion, and the third movable member and the fourth movable member extend outwardly from a second side of the support portion, the second side being opposite the first side.

16. The stand of claim 11, wherein the upper end of the support member is located between the first leg and the second leg of the doll.

17. A toy assembly including a stand for a doll having a first leg and a second leg, the first leg having an outer surface defining a perimeter, the second leg having an outer surface defining a perimeter, the toy assembly comprising:
a stand including:
a base;
a support member coupled to the base and extending upwardly therefrom;
a first receiving portion coupled to the support member, at least a portion of the first receiving portion being located between the first leg and the second leg of the doll, the first receiving portion extending around a majority of the perimeter of the first leg; and
a second receiving portion coupled to the support member, at least a portion of the second receiving portion being located between the first leg and the second leg of the doll, the second receiving portion extending around a majority of the perimeter of the second leg.

18. The toy assembly of claim 17, wherein the first receiving portion defines a receptacle in which the first leg is inserted, and the second receiving portion defines a receptacle in which the second leg is inserted.

19. The toy assembly of claim 17, wherein the first receiving portion extends from a first side of the support member, the second receiving portion extends from a second side of the support member, the first side being opposite to the second side.

20. The toy assembly of claim 17, further comprising:
the doll.
